(19) United States
(12) Patent Application Publication
(10) Pub. No.: US 2014/0222525 A1
(43) Pub. Date: Aug. 7, 2014

(54) RADIO FREQUENCY IDENTIFICATION (RFID) DATA COLLECTION SYSTEMS AND METHODS AND RETURN ON INVESTMENT PROCESSING OF RFID DATA COLLECTION SYSTEMS AND METHODS

(71) Applicant: PORTABLE TECHNOLOGY SOLUTIONS, LLC, Calverton, NY (US)

(72) Inventors: Howard Harold Heckman, III, Eastport, NY (US); Daniel Joseph Peluso, Hamilton, NJ (US); Bradley Joseph Horn, East Moriches, NY (US)

(73) Assignee: Portable Technology Solutions, LLC, Calverton, NY (US)

(21) Appl. No.: 13/760,255

(22) Filed: Feb. 6, 2013

(51) Int. Cl. G06F 17/50

(52) U.S. Cl. CPC G06F 17/5009
USPC 705/7.37; 703/13

(57) ABSTRACT

A Radio Frequency IDentification (RFID) simulator system is provided. The RFID simulator system includes a processor effective to receive first data representing a pre-existing system for tracking of objects; simulate an RFID system having at least one RFID reader, at least one RFID antenna, and a plurality of objects connected to RFID tags; simulate a path of the objects; simulate an RFID system environment to produce second data representing simulated RFID tracking of the objects; and compare first data and second data to generate third data; and at least one memory effective to store at least one of the first data, the second data and the third data.

### TECHNICAL FIELD

The present disclosure generally relates to Radio Frequency IDentification (RFID) devices, systems and methods, and more particularly, to RFID devices used in the tracking of a plurality of objects in a defined space and determining a Return On Investment (ROI) of an RFID system.

### BACKGROUND

Various manual and/or electronic systems exist to track objects such as vehicles, inventory and/or personnel at defined locations. These systems include a physical counting of objects, e.g. manual inventory, electronic scanning of tags attached to objects, e.g. an electronic inventory, or employee tracking via identification badges or time clocks. Many of these systems require extensive man hours at high labor costs to conduct and complete the tasks at hand.

On form of electronic system is a Radio Frequency IDentification (RFID) system. A typical RFID system includes RFID tags that transmit signals identifying the objects to which they are attached and RFID readers that receive the signals from the RFID tags and forward the signals to a processor for further processing.

To properly operate an RFID system, careful and detailed planning must be done to determine optimal locations for the RFID readers and antennas attached thereto to provide proper coverage of the locations at which the RFID system is deployed. The antennas must be carefully positioned and tested, then repositioned and retested to optimize accuracy and coverage. The environment, objects, materials, and tags will all affect the read performance, speed and accuracy of the antennas. This testing, along with supporting system integration, is required in order to eventually arrive at a properly planned RFID system. This planning and initial implementation process requires extensive man-hours before a proof of concept or a determination of a return on the investment can be achieved. Without this knowledge, a company may even decide against attempting an implementation since a true return on investment can not be calculated.

This disclosure describes an improvement over these prior art technologies.

### SUMMARY

Accordingly, a Radio Frequency IDentification (RFID) simulator system is provided that includes a processor effective to receive first data representing a pre-existing system for tracking of objects; simulate an RFID system having at least one RFID reader, at least one RFID antenna, and a plurality of objects connected to RFID tags; simulate a path of the objects; simulate an RFID system environment to produce second data representing simulated RFID tracking of the objects; and compare first data and second data to generate third data; and at least one memory effective to store at least one of the first data, the second data and the third data.

Accordingly, a method for a simulating a Radio Frequency IDentification (RFID) system is provided that includes: storing in a memory first data representing a non-simulated tracking of objects; simulating by a processor an RFID system having at least one RFID reader, at least one RFID antenna, and a plurality of objects connected to RFID tags; simulating by the processor a path of the objects; simulating by the processor an RFID system environment to produce second data representing simulated RFID tracking of the objects; reading from the memory by the processor the first data; comparing by the processor first data and second data to generate third data; and storing the second data and the third data in the memory.

Accordingly, a computer program device readable by a machine, tangibly embodying a program of instructions executable by the machine is provided that includes: storing in a memory first data representing a non-simulated tracking of objects; simulating by a processor an RFID system having at least one RFID reader, at least one RFID antenna, and a plurality of objects connected to RFID tags; simulating by the processor a path of the objects; simulating by the processor an RFID system environment to produce second data representing simulated RFID tracking of the objects; reading from the memory by the processor the first data; comparing by the processor first data and second data to generate third data; and storing the second data and the third data in the memory.

### BRIEF DESCRIPTION OF THE DRAWINGS

The present disclosure will become more readily apparent from the specific description accompanied by the following drawings, in which:

FIG. 1 is a diagram illustrating a Radio Frequency IDentification (RFID) simulator system according to the present disclosure;

FIG. 2 is a flowchart illustrating a method for simulating an RFID system according to the present disclosure;

FIG. 3 is a diagram illustrating of a user interface of a virtual site;

FIG. 4 is a diagram illustrating a user interface of the virtual site of FIG. 4 with RFID readers;

FIG. 5 is a diagram illustrating a user interface of the virtual site of FIG. 5 with RFID antenna, node points, and data tags;

FIG. 6 is a diagram illustrating a user interface of the virtual site of FIG. 6 with waypoints and an animation path;

FIG. 7 is a flowchart illustrating a method for synchronizing databases for an RFID system according to the present disclosure; and

FIG. 8 is a flowchart illustrating method for determining a Return on Investment (ROI) for an RFID system according to the present disclosure.

Like reference numerals indicate similar parts throughout the figures.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure.

Reference will now be made in detail to the exemplary embodiments of the present disclosure, which are illustrated in the accompanying figures.

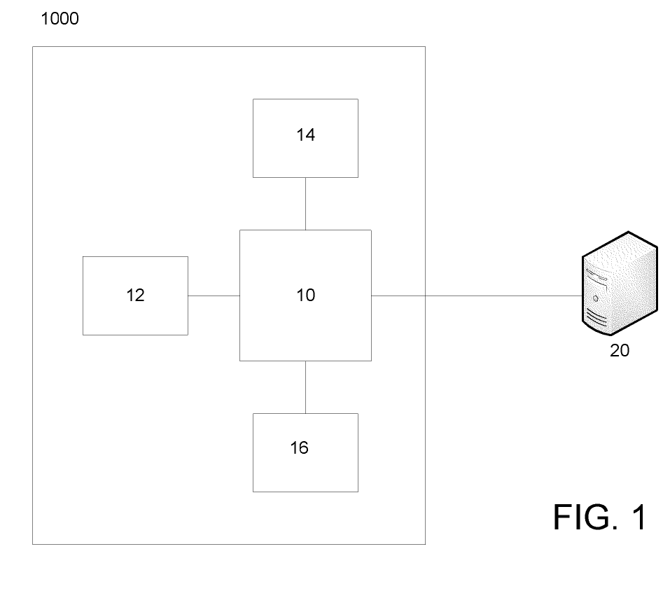

As shown in FIG. 1, Radio Frequency IDentification (RFID) simulator system 1000 according to the present disclosure includes a processor 10 for processing data and performing general control for system 1000, a memory 12 for storing data and programs, at least one input device 14 (e.g. a keyboard, a mouse, a pointing device, a stylus, etc.) for inputting commands, and a display 16 for displaying various user interfaces and simulated RFID system environments. RFID simulator system 1000 is connectable to other systems 20. These other systems can be databases, personal computers, servers, the Internet, etc. The connection between RFID simulator system 1000 and other systems 20 can be, for example, hardwired or wireless, local or distant, a local area network or the Internet. Other connections are contemplated.

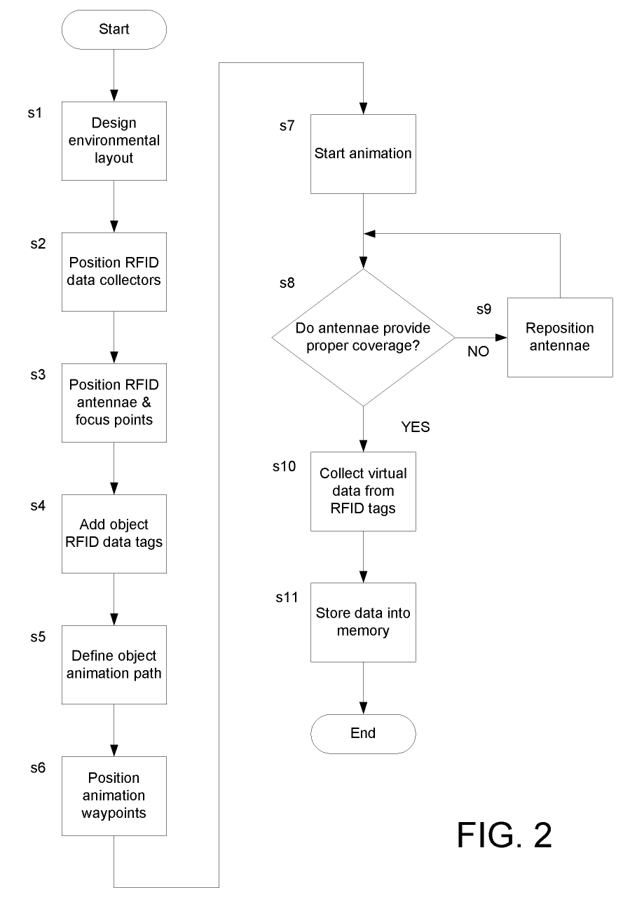

The system and method for simulating an RFID system according to the present disclosure will now be described with respect to FIGS. 2-6.

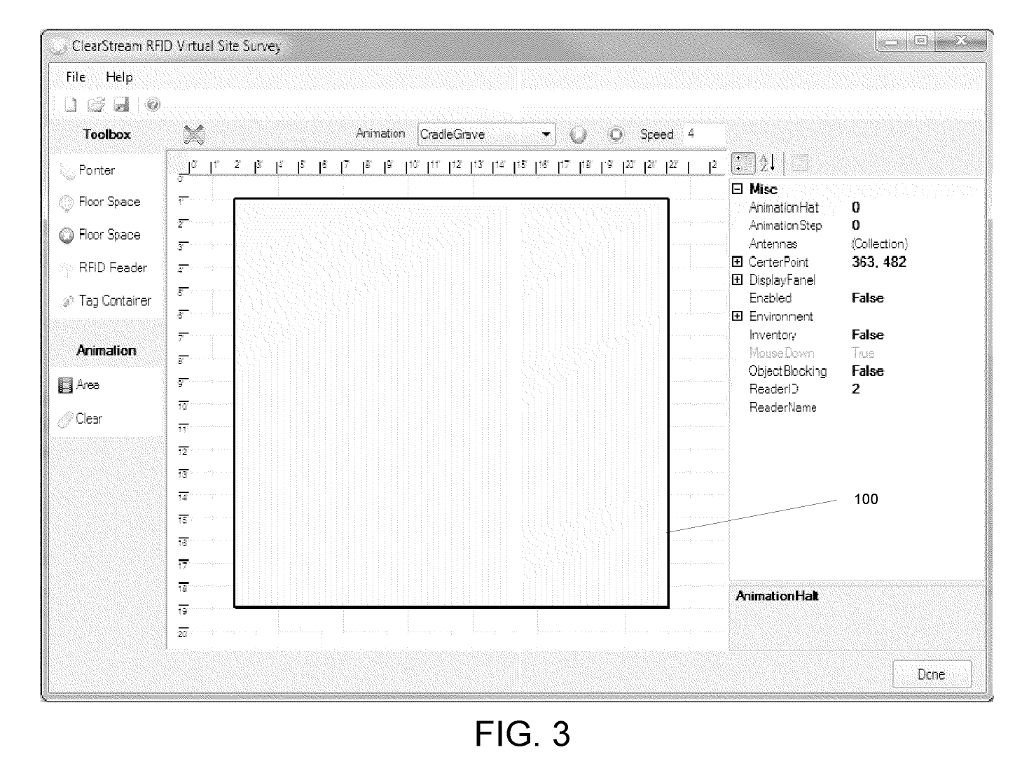

In step s1 the system provides a user interface for a user to design a virtual environment 100 layout as shown in FIG. 3. The virtual environment 100 is meant to represent as closely as possible an actual environment into which a real-time RFID system is to be integrated. The virtual environment can be for example a room, a loading dock, a storage facility, a warehouse or even an outdoor environment. Other virtual environments are contemplated. Any shape and/or size environment can be selected at the initial layout. Although not shown, the design process can also include the positioning of walls, the defining of the ceiling height, the positioning of furniture, inventory storage shelves, etc. The more detailed the design of the environment, the more accurate to real life the virtual system will perform. Well known drop-and-drag programming is included in system 1000 to facilitate ease of configuration of virtual environment 100.

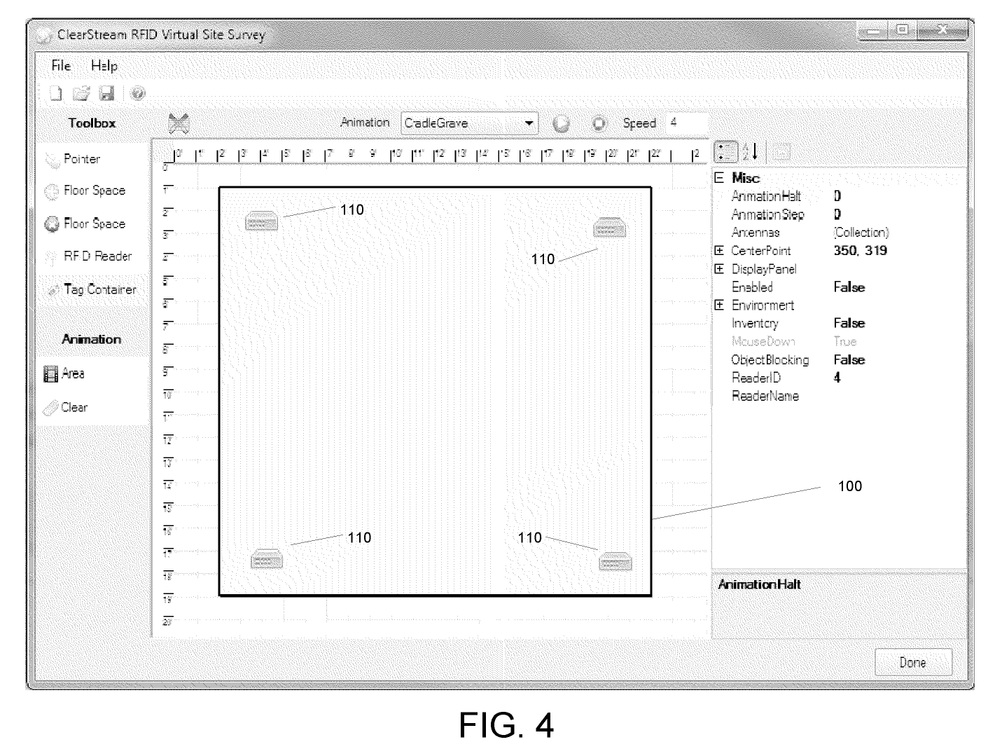

In step s2 RFID data readers (or data collectors) 110 are positioned in virtual environment 100 as shown in FIG. 4. The initial position and number of readers 110 will depend on a rough estimate of virtual environment 100 that was designed in step s1. In addition, system 1000 can provide various makes and models of the readers for varying applications. Readers 110 can be repositioned during the process.

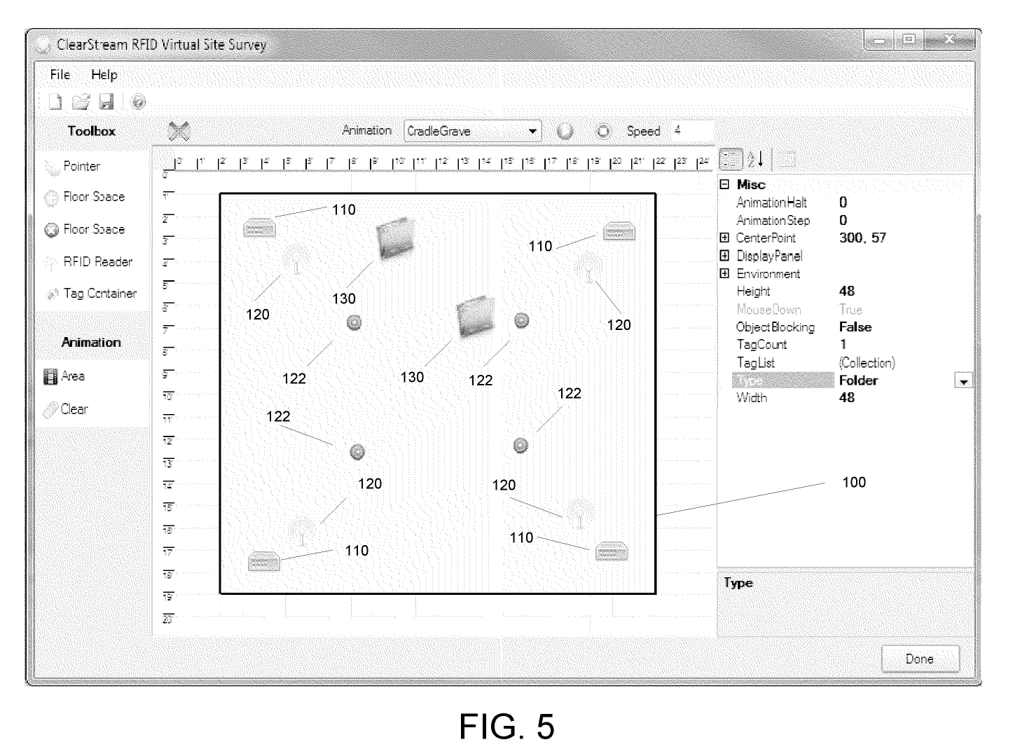

In step s3 RFID antennas 120 and focus points 122 are positioned as shown in FIG. 5. The initial position and number of antennas 120 will depend on the requirements of the system. For example, an antenna that requires a hardwired connection with its reader will be positioned within a radius of the wire requirements. In addition, as some readers can accommodate multiple antennas, the reader type will define the number of antennas attached to each reader. Further, antenna model and specifications will effect the initial placement of the antenna as a coverage area of different antenna can vary greatly. Also shown in FIG. 5 are antenna focus points 122. As most antennas in an RFID system are unidirectional (i.e. receive signals from less than an entire radius about the antenna), the focus direction of antenna 120 is defined by the placement of antenna focus points 122. The virtual electronic devices described herein are designed and programmed in part to react as real time components.

In step s4, objects 130 having RFID data tags attached thereto are defined. Objects 130 in this example are shown as folders, but the system can depict various types of objects, including, but not limited to, boxes, people, etc. Objects 130 may have widely differing characteristics, such as material, size, tag type, etc., all of which require careful consideration when developing the environment. These characteristics can be included as data programmed into the tags. Tags can also identify environmental conditions such as temperature and shock, etc. The considerations will affect the read performance, speed and accuracy of the system.

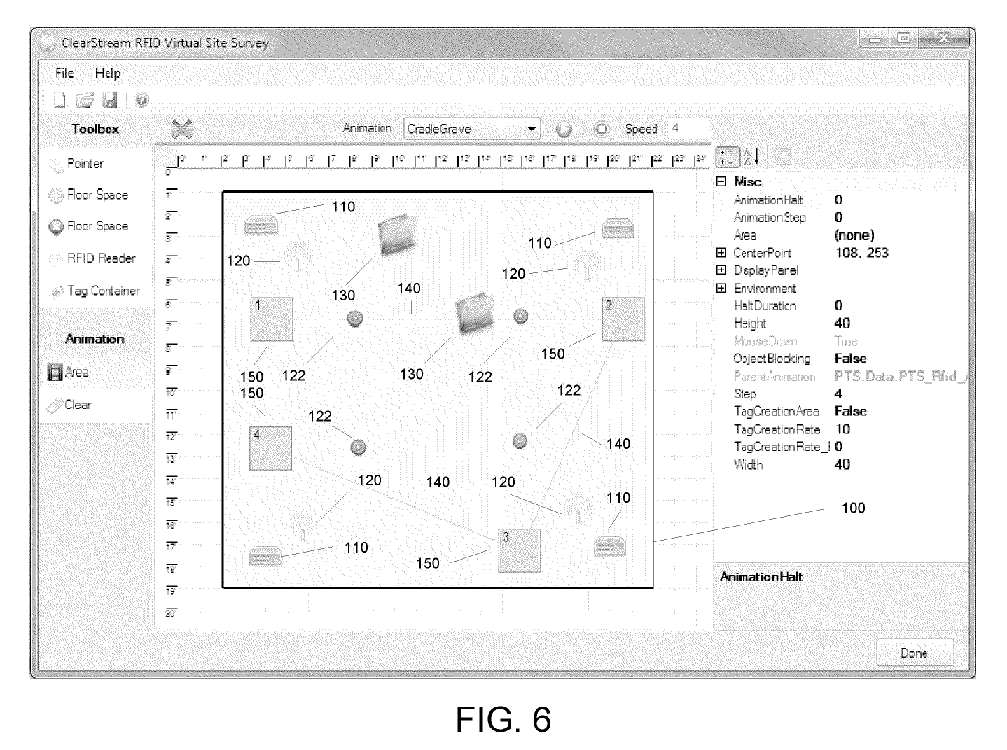

In step s5, and as shown in FIG. 6, animation path 140 is defined. Path 140 will traverse through virtual environment 100 and can be designed to avoid walls, furniture, etc. as originally laid out in environment 100 in step s1. In addition, in step s6 waypoints 150 are positioned in environment 100. Waypoints 150 are user defined areas where objects 130 are to be tracked and/or stored during the animation. Waypoints 150 are utilized to simulating the movement and storage of objects 130 in a real-time environment.

After the virtual environment 100 has been designed with the RFID components (i.e. readers 110, antennae 120 and object tags 130) positioned therein, in step s7 the animation is then started to begin a coverage test.

In step s8 system 1000 activates readers 110 and antennas 120 in virtual environment 100. System 1000 is programmed to simulate a real time RFID system according to the pre-existing system, with or without RFID components. As objects 130 move along animation path 140, system 1000 determines if each reader 110, through their respective antennas 120, can detect the data tags on objects 130. If a particular reader/antenna 110/120 combination cannot detect the RFID tags, in step 9 a user can reposition the antenna to correct the coverage area, after which the process returns to step s8. If all of readers 110 and antennas 120 can read the data tags on objects 130, the process proceeds to step s10 and begins to collect the virtual data from the RFID tags attached to objects 130. As the animation continues, the speed of objects 130 traversing along animation path 140 can be adjusted to determine a maximum speed at which the simulated RFID system can operate and still read all of the RFID tags on objects 130. In step s11, processor 10 can store data collected during the process in memory 12. This data can include data from the RFID tags on objects 130 as well as simulation results (e.g. speed/data collection rates) from the operation of the virtual RFID system.

Additional data that can be collected by the system can include a tag identifier, date/time stamps for when a tag is read, reader and/or antenna identification during the reading process, length of time an object is at a waypoint, initial and/or final detection by a particular antenna, a signal strength of a read tag to determine read performance of an object at a particular antenna, and environmental measurements (e.g. temperature, pressure, humidity), forces exerted on the tags (e.g. accelerometer readings, gyroscopic readings), Global Positioning System (GPS) coordinates, etc. Other data is contemplated. The data collected can be used to calculate various ROI data for analysis.

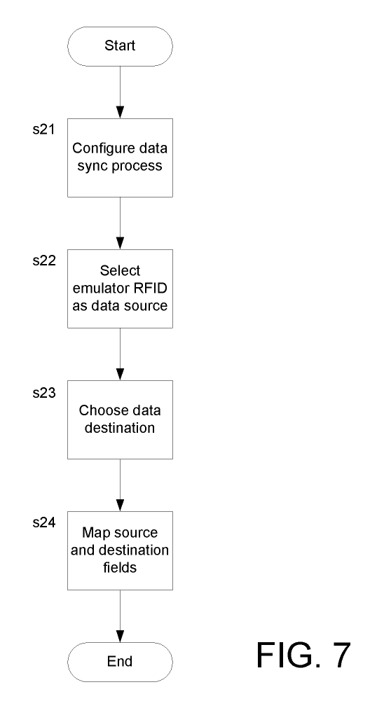

In addition to storing the collected data in memory 12, system 1000 also configures data synchronization with real time data and databases as shown in FIG. 7. In order to illustrate to a user the efficiency of the simulated RFID system, system 1000 can be instructed to interact with databases that have previously collected real time data. This real time data can typically be data obtained by an existing RFID system or other inventory and/or personnel tracking systems. By utilizing this process, comparisons can be made between the previous systems and the virtual RFID system.

In step s21, system 1000 enters into the data synchronization (sync) process. In step s22, a user, through the use of a user interface, selects the virtual RFID system as the data source. This will be the data that is obtained during the virtual RFID environment simulation. In step s23 the user selects a destination database into which the data will be stored. This database can be, for example, an Open DataBase Connectivity (ODBC) system, a spreadsheet program, or a text file. Other databases are contemplated. In step s24, a user maps the source fields to the destination fields in the selected database. Then, as the data is collected by the virtual RFID system as described above, this data can be input into the selected database for future use and comparison purposes.

One contemplated use of the data collected is to determine a Return On Investment (ROI) of upgrading a real time system (RFID and/or non-RFID based) to an RFID system that is to be implemented based on the virtual RFID system that was simulated as described above.

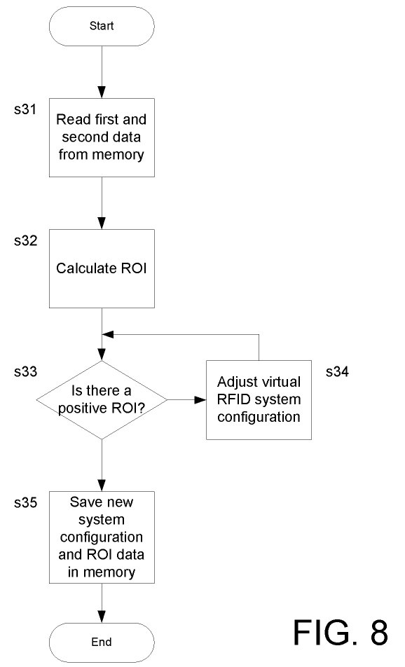

As shown in FIG. 8, in step s31, processor 10 reads both the real time data, e.g. first data, and the simulated data, e.g. second data, from the memory in which it is stored. As described above, this can be memory 12 of system 1000 or a separate database as described above. In step s32 the data is then used to calculate the ROI as shown in Equation 1:

$$ROI = \frac{( {I}_{G} - {I}_{C} )}{{I}_{C}} \qquad ( 1 )$$

where I_{G} is the gain from the investment and I_{C} is the cost of the investment. The gain from the investment can be based on the increase of productivity if the virtual RFID system is implemented in real time. The ROI can be determined at different points and waypoints during the simulation process and at an end of the simulation process. The ROI is calculated by determining a difference between existing system/process values and values determined by the simulation process using the RFID environment and objects.

In step s33 a determination is made whether the ROI is significant. If the calculation does not produce a significant ROI, the virtual RFID system configuration can be adjusted to create a more attractive ROI. If the calculation does produce a significant ROI, new system configuration and ROI data can be saved in a memory.

The ROI of the virtual RFID system is used to indicate the value of the proposed RFID system on which the virtual RFID system is based. System 1000 takes into account that ROI calculations vary dramatically depending on the process or system in the existing environment being measured. Also, in determining the ROI of the proposed RFID system, system 1000 takes into account that each existing environment can vary dramatically. These differences can affect the end result and ROI in a way that only the simulated RFID environment or actual installation of the hardware can accurately calculate; the latter of which requires a significant upfront investment, which may not have a positive ROI to begin with. System 1000 takes into account the flexibility needed by adjusting to different processes via configurable waypoint ROI calculations.

In a preferred embodiment, three data sets (e.g. first data, second data and third data) are used to calculate the ROI of the RFID system.

Data set 1 is defined as the current relevant costs associated with the existing system and the problem the proposed system is being designed to alleviate. The costs can be direct costs such as material and labor or indirect costs such as poor quality, inaccurate data etc. System 1000 as show in the following examples is designed to be flexible in that each of the costs can be added as needed through system 1000.

Data set 2 is defined as the costs associated with the future system to complete the same process or set of processes that are realized by the existing system. These costs are estimated through the implementation of a virtual RFID system using system 1000. Eliminated or improved hidden costs can also be entered into the system to offer a more complete ROI calculation.

During the initial setup of a simulated environment system 1000 receives known costs associated with the process that is to be replaced with the proposed RFID installation. These known costs can be entered by a user or received from an existing database stored in a memory of another system (e.g. other systems 20). System 1000 can receive any number of known costs. The known costs are used to calculate the current costs associated with the existing system. The known costs and costs associated with the existing system are stored in memory 12 as data set 1.

The data of data set 1 can include, for example, man hours required to implement the existing system, an average number of lost goods during a specified time period, an accuracy of inventory and how often it needs to be updated. Other items used to determine total cost are contemplated.

System 1000 generates data set 2 through the analysis of the virtual RFID system. As described above, system 1000 implements a virtual RFID system through the setup of the virtual environment based on an existing environment, the positioning of the readers in the virtual environment, and the selecting of materials and tags that will affect the performance of the simulated system. The animation of the process is configured to describe movement of goods, people, and/or other objects that will be used in the ROI calculation.

As described above, data set 2 can include data from the RFID tags on objects 130 as well as simulation results (e.g. speed/data collection rates) from the operation of the virtual RFID system, tag identifiers, date/time stamps for when a tag is read, reader and/or antenna identification during the reading process, length of time an object is at a waypoint, initial and/or final detection by a particular antenna, a signal strength of a read tag to determine read performance of an object at a particular antenna, temperature, pressure, humidity measurements, accelerometer readings, gyroscopic readings, GPS coordinates, etc. the more data available to system 1000, the more accurate and real-time the ROI.

As described above, after the setup of the virtual RFID system, the simulation is started and system 1000 can determine, for example, the following: new costs associated with the infrastructure of the proposed RFID system, coverage of the required environment to provide feedback for the effectiveness of the proposed system, read performance using selected tags, and environment variables defined by the user. Other determinations are contemplated.

At the completion of the simulation, ROI calculations can occur. The resulting calculations can be displayed to a user on display 16. In the preferred embodiment the displayed results can include an ROI calculated by a difference between an element or elements of data set 1 and data set 2, as well as the accuracy of the virtual system. Generally, a positive ROI indicates an acceptable system and a negative ROI an unacceptable configuration. System 1000 can also determine and display if items are lost during a path from one waypoint to another, which can be a significant factor in RFID tracking implementation.

System 1000 can indicate the performance of the virtual RFID system, e.g. degrees of accuracy and coverage of the virtual environment, which can be used to adjust and maximize performance, e.g. accuracy and coverage, and run the simulation until acceptable results are achieved. After the simulation, modifications to the simulation can be made to maximize system performance. For example, if system 1000 indicates that RFID coverage was not optimal at a particular area, e.g. did the system effectively cover the floor space of the environment, adjustments can be made in the virtual environment. Also, system 1000 might indicate that the tags used did not provide the performance necessary for the system to function properly, and a different model of tag can be selected in the virtual environment and rerun the simulation. As a further example, system 1000 might indicate that not all data from the tags collected as required and pushed to the memory, and as such additional fields in a database might be added to allow for optimal data collection and rerun the simulation.

These performance indications cannot normally be determined without the proposed virtual RFID system, other than through trial and error with actual hardware and installation, which is costly and time-consuming. Therefore the ROI calculation can be made while also limiting failure of an expensive investment without a successful end result further benefitting the ROI.

The invention is further illustrated by the following specific examples, which are not intended in any way to limit the scope of the invention.

### Example 1

### Basic Inventory

In a first example, Company XYZ performs a monthly inventory via a mobile barcode system. In this type of system, handheld scanners are used by employees to scan each individual object in inventory. The scan results are downloaded from the scanner to a database and reports are generated to indicate the items and amounts of the items in inventory. For this example, Company XYZ only tracks the labor costs associated with the current process. These labor costs are collected and input into system 1000 as data set 1. It is noted that other hidden and direct costs are not being tracked by Company XYZ, for example, cost of labels, cost of accuracy, etc. IN this example, 200 man hours and 5 handheld scanners are required to complete an inventory. The employees received $50.00 per hour and the scanners cost $1500.00 each. Thus, in this example, the following data is received by system 1000 and stored in memory 12: 200 man hours, $50.00 per hour, $1500 per scanner, 5 scanners. System 1000 calculates the labor costs per inventory of:

200 man hours×$50.00=$10,000.00

and one-time hardware costs of:

$1500 per scanner×5 scanners=$7500.00.

This data can be received by system 1000 via entry by a user or retrieved from an existing database maintained by Company XYZ.

After entering the costs associated with the process to be replaced, system 1000 receives data to design and describe the environment and objects to be tracked of Company XYZ by the proposed RFID system. This data can include the following: a floor plan of the XYZ Company's warehouse; RFID readers and antennas needed to perform an accurate inventory; the type of tags to be used (e.g. model numbers, coverage areas, cost, etc.); waypoints, configured to define steps required for animation of the objects throughout the warehouse. Initially, as part of data set 2, the hardware costs of the RFID system (based on the virtual system) is received by system 1000 and stored in memory 12. In this example, no man hours are required for an inventory using the RFID system and 3 readers are required. Each reader has a one-time cost of $1500.00. System 1000 calculates the labor costs per inventory of:

0 man hours×$50.00=$0.00

and one-time hardware costs of:

$1500 per reader×3 readers=$4500.00.

System 1000 can then calculate the ROI based on the difference between the costs of data set 1 and data set 2.

After configuring the virtual RFID environment for Company XYZ, system 1000 runs the simulation. ROI data metrics are collected along with visual confirmation that the system is collecting data as expected. Data that comprised data set 3 is then calculated. In addition, system 1000 determines the accuracy of the virtual RFID system, and the ROI calculation returned, showing whether or not the proposed system will be a beneficial and positive replacement of their existing process.

### Example 2

### Child Day Care Center

It is well known that some ROI calculations are not easily formulated. Many times an ROI must be determined based on reducing risk or calculating against costs never realized. This example will illustrate the use of system 1000 to simulate the function of a day care center's daily operations and determine an ROI based thereon.

Again, the initial step is to determine the current costs associated with the existing system, a child day care center. In this example two staff members are required to track children being dropped off at a front gate. Parents, at times, have to wait up to 10 minutes to drop off or pick up children. Staff spends approximately 30 minutes at the gate per day reviewing identifications and documenting drop-offs. One administrator spends 60 minutes per day entering log data into a spreadsheet for permanent records tracking. The staff is also required to track children as they move around the facility and log certain daily events including but not limited to bathroom breaks, meals etc. It is estimated that these activities require 4 hours per week for staff and an additional 3 hours per week for administrators to log and communicate with parents. Thus, system 1000 receives the following data, which is stored in memory 12: gate tracking: check-in 2.5 hours per week for staff, labor rate of $15.00 per hour for staff, logging: 2.5 hours per week for administration, labor rate of $30.00 per hour for administration; daily event tracking 4 hours per week for staff, 3 hours per week for administration.

System 1000 calculates the labor costs per event:

Gate tracking:
Check-in: 2.5 hrs per week×$15.00/hr=$37.50 per week
Logging: 2.5 hrs per week×$30.00 per hour=$75.00 per week

Daily Event Logging:
Event tracking: 4 hrs per week×$15.00=$60.00 per week
Logging/Communication: 3 hrs per week×$30.00=$90.00 per week.
   Total weekly labor costs are calculated at $262.50. Hardware costs are not considered in the existing system, but can be entered to provide a more accurate analysis and comparison. As in the first example, this data can be manually entered into system 1000 or retrieved by system 1000 from an existing database of the day care center.

After entering the costs associated with the process to be replaced, system 1000 receives data to design and describe the environment and objects to be tracked of the child care center by the proposed RFID system. This data can include the following: a gate plan and floor plan of the center; RFID readers and antennas needed to perform accurate child tracking; the type of tags to be used (e.g. model numbers, coverage areas, cost, etc.); waypoints, configured to define steps required for animation of the children throughout the center. Initially, as part of data set 2, the hardware costs of the RFID system (based on the virtual system) is received by system 1000 and stored in memory 12. In this example, no man hours are required for tracking the children using the RFID system and it is estimated that 3 readers are required. Each reader has a one-time cost of $1500.00. System 1000 calculates the labor costs to track the children is $0.00, and one-time hardware costs of:

$1500 per reader×3 readers=$4500.00.

System 1000 can then calculate the ROI based on the difference between the costs of data set 1 and data set 2.

After configuring the virtual RFID environment for the center, system 1000 runs the simulation. ROI data metrics are collected along with visual confirmation that the system is collecting data as expected. Data that comprises data set 3 is then calculated. In addition, system 1000 determines the accuracy of the virtual RFID system, and the ROI calculation returned, showing whether or not the proposed system will be a beneficial and positive replacement of their existing process. At the current costs per week, this virtual RFID system determines that a real-time RFID system breaks even in an approximate 18 weeks.

Additional ROI calculations can be made to illustrate that the center can increase student capacity without an increase in operational costs. If an additional 5 students can be added to the daily capacity of the facility, this results in an increase of $400 per week per new student. This substantially reduces the above mentioned time to ROI.

As described above, the present disclosure provides for systems and methods that can be used to simulate a virtual RFID environment and use data collected therein to estimate a return on investment if the virtual RFID system were to be implemented in real time. This can provide a powerful marketing and sales tool for RFID system providers.

In addition, although the present disclosure has been described herein as relating to RFID technology, the system and methods described herein can be applied to other technologies, for example, bar code based inventory tracking system or Smart Card based inventory tracking systems. Other systems are contemplated.

Where this application has listed the steps of a method or procedure in a specific order, it may be possible, or even expedient in certain circumstances, to change the order in which some steps are performed, and it is intended that the particular steps of the method or procedure claim set forth here below not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A Radio Frequency IDentification (RFID) simulator system, comprising:
a processor effective to
receive first data representing a pre-existing system for tracking of objects;
simulate an RFID system having at least one RFID reader, at least one RFID antenna, and a plurality of objects connected to RFID tags;
simulate a path of the objects;
simulate an RFID system environment to produce second data representing simulated RFID tracking of the objects; and
compare first data and second data to generate third data; and
at least one memory effective to store at least one of the first data, the second data and the third data.

2. The system of claim 1, wherein the third data represents a change between the pre-existing system for tracking of the objects and the simulated RFID tracking of the objects.

3. The system of claim 1, wherein the processor is further effective to calculate a return on investment (ROI) based on
$$ROI = \frac{( {I}_{G} - {I}_{C} )}{{I}_{C}}$$
where I_{G} is a gain from the simulated RFID system and I_{C} is the cost of the simulated RFID system.

4. The system of claim 1, wherein the processor is further effective to
receive instructions for placement of the RFID reader;
receive instructions for placement of the antenna; and
simulate a coverage pattern of the antenna.

5. The system of claim 1, wherein the processor is further effective to
receive instructions for configuring the path of the objects;
animate movement of the objects along the path; and
determine if the objects are within the coverage pattern of the antenna.

6. The system of claim 1, wherein the processor is further effective to
receive instructions regarding a physical layout of the RFID system environment; and
simulate the physical layout of the RFID system environment based on the received instructions.

7. The system of claim 1, wherein the instructions regarding the physical layout includes at least one physical dimensions of the environment, furniture within the environment, materials used to construct the environment, access ways of the environment.

8. The system of claim 1, further comprising a display to display the simulated RFID system environment.

9. A method for a simulating a Radio Frequency IDentification (RFID) system, comprising the steps of:
storing in a memory first data representing a non-simulated tracking of objects;
simulating by a processor an RFID system having at least one RFID reader, at least one RFID antenna, and a plurality of objects connected to RFID tags;
simulating by the processor a path of the objects;
simulating by the processor an RFID system environment to produce second data representing simulated RFID tracking of the objects;
reading from the memory by the processor the first data;
comparing by the processor first data and second data to generate third data; and
storing the second data and the third data in the memory.

10. The method of claim 9, wherein the third data represents a change between the non-simulated tracking of the objects and the simulated RFID tracking of the objects.

11. The method of claim 9, further comprising calculating a return on investment (ROI) based on
$$ROI = \frac{( {I}_{G} - {I}_{C} )}{{I}_{C}}$$
where I_{G} is a gain from the simulated RFID system and I_{C} is the cost of the simulated RFID system.

12. The method of claim 9, further comprising:
receiving instructions for placement of the RFID reader;
receiving instructions for placement of the antenna; and
simulating a coverage pattern of the antenna.

13. The method of claim 9, further comprising:
receiving instructions for configuring the path of the objects;
animating movement of the objects along the path; and
determining if the objects are within the coverage pattern of the antenna.

14. The method of claim 9, further comprising:
receiving instructions regarding a physical layout of the RFID system environment; and
simulating the physical layout of the RFID system environment based on the received instructions.

15. The method of claim 9, wherein the instructions regarding the physical layout includes at least one physical dimensions of the environment, furniture within the environment, materials used to construct the environment, access ways of the environment.

16. The method of claim 9, further comprising displaying on a display the simulated RFID system environment.

17. A computer program device readable by a machine, tangibly embodying a program of instructions executable by the machine to perform method steps for:
storing in a memory first data representing a non-simulated tracking of objects;
simulating by a processor an RFID system having at least one RFID reader, at least one RFID antenna, and a plurality of objects connected to RFID tags;
simulating by the processor a path of the objects;
simulating by the processor an RFID system environment to produce second data representing simulated RFID tracking of the objects;
reading from the memory by the processor the first data;
comparing by the processor first data and second data to generate third data; and
storing the second data and the third data in the memory.

18. The computer program device readable by a machine of claim 17, wherein the third data represents a change between the non-simulated tracking of the objects and the simulated RFID tracking of the objects.

19. The computer program device readable by a machine of claim 17, further comprising calculating a return on investment (ROI) based on
$$ROI = \frac{( {I}_{G} - {I}_{C} )}{{I}_{C}}$$
where I_{G} is a gain from the simulated RFID system and I_{C} is the cost of the simulated RFID system.

20. The computer program device readable by a machine of claim 17, further comprising displaying on a display the simulated RFID system environment.
